(19) United States
(12) Patent Application Publication
(10) Pub. No.: US 2026/0057325 A1
(43) Pub. Date: Feb. 26, 2026

(54) Resource Orchestration Dynamic Sequencing and Task Prioritization

(71) Applicant: Blue Yonder Group, Inc., Scottsdale, AZ (US)

(72) Inventors: Ankit Belchandan, Durg (IN); Sai Sridhar Varahabhatla, Bangalore (IN); Pankaj Rathoure, Hyderabad (IN)

(21) Appl. No.: 19/378,990

(22) Filed: Nov. 4, 2025

Related U.S. Application Data
(63) Continuation-in-part of application No. 19/270,846, filed on Jul. 16, 2025.
Application No. 19/270,846 is a continuation-in-part of application No. 19/016,238, filed on Jan. 10, 2025.
(60) Provisional application No. 63/549,150, filed on Feb. 2, 2024.
(60) Provisional application No. 63/551,788, filed on Feb. 9, 2024.
(60) Provisional application No. 63/553,285, filed on Feb. 14, 2024.
(60) Provisional application No. 63/874,252, filed on Sep. 2, 2025.
(60) Provisional application No. 63/880,740, filed on Sep. 12, 2025.
(60) Provisional application No. 63/880,755, filed on Sep. 12, 2025.

(51) Int. Cl. G06Q 10/0631; G06Q 10/0633; G06Q 10/087

(52) U.S. Cl. CPC G06Q 10/06316; G06Q 10/06312; G06Q 10/0633; G06Q 10/087

(57) ABSTRACT

A system and method are disclosed for generating and scheduling resource usage tasks. The method includes identifying changes in a resource usage plan within a supply chain network, generating tasks based on the identified changes, determining a task priority of the generated tasks, generating a task schedule based on the determined task priority, and monitoring real time execution of the generated tasks according to the task schedule. The method further includes performing, in real time, dynamic re-sequencing and dynamic re-scheduling to account for a deviation from the schedule and detecting, in real time, an error and transmitting, in real time, one or more tasks to a mobile device to account for the detected error.

### CROSS-REFERENCE TO RELATED APPLICATIONS

The present disclosure is a continuation-in-part of U.S. patent application Ser. No. 19/270,846, filed Jul. 16, 2025, entitled “Dynamic Sequencing and Scheduling of Warehouse Tasks,” which is a continuation-in-part of U.S. patent application Ser. No. 19/016,238, filed Jan. 10, 2025, entitled “Dynamic Sequencing and End to End Process of Planogram Adjustments,” which claims priority to U.S. Provisional Application No. 63/551,788, filed Feb. 9, 2024, entitled “Dynamic Sequencing and End to End Process of Planogram Adjustments,” U.S. Provisional Application No. 63/553,285, filed Feb. 14, 2024, entitled “Radial Visualization of Planogram Adjustments,” and U.S. Provisional Application No. 63/549,150, filed Feb. 2, 2024, entitled “Task Prioritization and Dynamic Modification of Task Sequence.” The present disclosure also claims priority to U.S. Provisional Application No. 63/874,252, filed Sep. 2, 2025, entitled “Supply Chain Fulfillment Using End-to-End Dynamic Tasking,” U.S. Provisional Application No. 63/880,740, filed Sep. 12, 2025, entitled “Sustainable Supply Chain Fulfillment based on Dynamic Tasking,” and U.S. Provisional Application No. 63/880,755, filed Sep. 12, 2025, entitled “Transportation Task Prioritization.” U.S. patent application Ser. Nos. 19/270,846, 19/016,238 and U.S. Provisional Application Nos. 63/551,788, 63/553,285, 63/549,150, 63/874,252, 63/880,740 and 63/880,755 are assigned to the assignee of the present application.

### TECHNICAL FIELD

The present disclosure relates generally to supply chain planning and execution and specifically to orchestrating resources within a supply chain.

### BACKGROUND

In supply chain planning and execution for logistics, transportation and fulfillment, including vehicle yard management, resource usage plans are generated periodically, such as daily, and thereafter executed by, for example, transferring resources, such as equipment or human resources such as workers, from one location to another within the supply chain. However, in some situations a resource usage plan may be updated, such as a new resource usage plan being generated midway through a day or midway through a shift, for a variety of reasons, such as in response to the receipt of an unexpected number of orders, the receipt of orders with rush or expedited fulfillment. Further, during supply chain operations, unexpected changes not part of the resource usage plan may occur, necessitating updated plans or operational schedules. Using existing supply chain management systems, when a change to supply chain operations is needed for any reason, supply chain entities utilizing one or more resources and their employees may struggle to implement the change effectively. For example, updated resource usage plans may be difficult for employees to understand, in some cases it may be overly complex to determine how to implement a resource usage plan change and any changes that are implemented may be performed ad-hoc and in an inefficient manner that disrupts the operation of the supply chain entity in its entirety. For these reasons and more, existing supply chain management systems that implement operational changes lack an ability to efficiently and competently implement updates or changes to resource orchestration and may disrupt resource usage and other supply chain operations, all of which is undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with an embodiment;

FIG. 2 illustrates the resource orchestration system, the archiving system and the planning and execution system of FIG. 1 in greater detail, in accordance with an embodiment;

FIG. 3 illustrates an example resource orchestration network, according to an embodiment;

FIG. 4 illustrates an example method for generating and scheduling resource usage tasks, according to an embodiment;

FIG. 5 illustrates an example method for resource orchestration, according to an embodiment;

FIG. 6 illustrates an example method for assigning resources to tasks, according to an embodiment;

FIG. 7 illustrates an example method for rebalancing resource allocation, according to an embodiment; and

FIG. 8 illustrates an example method for resource orchestration simulation, according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described in more detail below, embodiments of the following disclosure provide systems and methods to automatically detect changes in resource usage operations or in an updated resource usage plan and execute the detected changes via dynamic task generation, sequencing and scheduling. Embodiments may detect a change in a resource usage plan compared to an initial resource usage plan and generate, based on the change, one or more tasks to be performed to implement the change. Embodiments may also detect a change in resource orchestration or resource usage based on real-time data and generate one or more tasks to be performed based on the detected change. Embodiments may then determine task priority for the one or more tasks and generate a task schedule for the one or more tasks based on the task priority. Embodiments may then transmit to a device associated with workers or resources instructions to perform a task of the one or more tasks, with the task selected according to the task schedule. Embodiments may then monitor execution yard tasks in order to enable dynamic task re-sequencing and re-scheduling if a deviation from the task schedule is detected. Embodiments may optimize the generation and scheduling of resource usage tasks to improve overall efficiency of resource usage.

Embodiments provide ensembled techniques that combine multiple algorithms to generate tasks, determine task priority and dynamically sequence and schedule tasks to be performed to implement resource management changes. Use of embodiments may increase accuracy of resource usage task execution. Embodiments provide tools to view, analyze and execute resource usage tasks at several different scopes. Use of embodiment may reduce time spent analyzing or identifying resource usage tasks as well as the time spent taking corrective measures following execution incorrectly performed. Use of embodiments provides effective and efficient handling of resource usage tasking by providing enhanced resource usage task understanding as well as determining and providing shortest possible paths to perform resource usage tasks. Use of embodiments may enable improved compliance with resource usage plans at both a supply chain entity level and a supply chain or supply chain network level. Use of embodiments may result in resource usage or resource orchestration that is more efficient and optimal than is possible with existing resource management solutions.

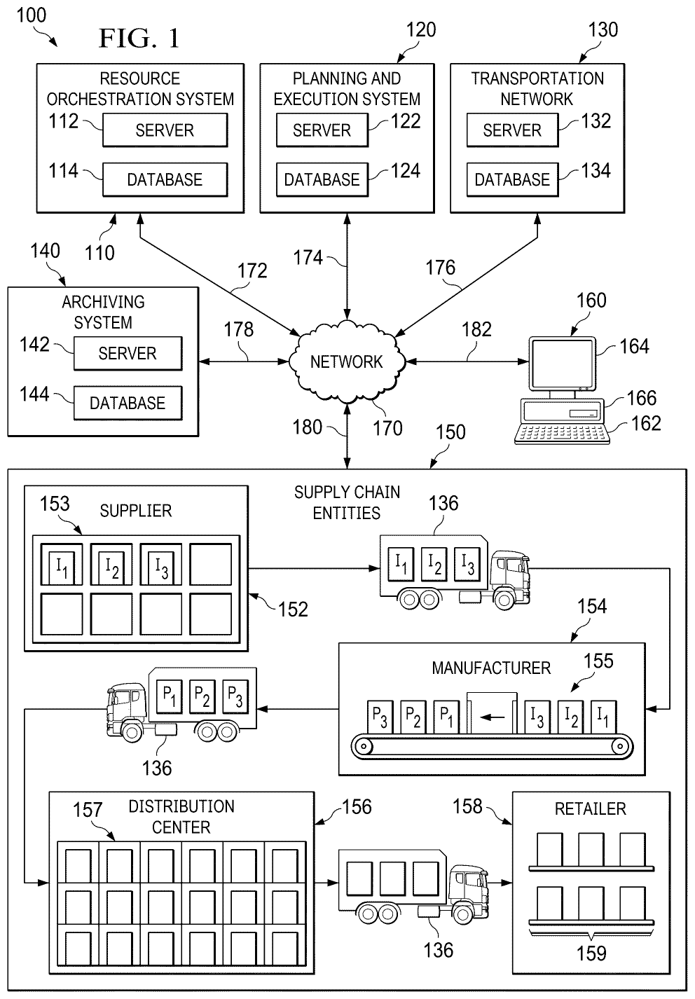

FIG. 1 illustrates supply chain network 100, in accordance with a first embodiment. Supply chain network 100 comprises resource orchestration system 110, planning and execution system 120, transportation network 130, archiving system 140, one or more supply chain entities 150, computer 160, network 170, and one or more communication links 172-180. Although a single resource orchestration system 110, a single planning and execution system 120, a single transportation network 130, a single archiving system 140, one or more supply chain entities 150, a single computer 160, a single network 170 and one or more communication links 172-180 are shown and described, embodiments contemplate any number of the above at one or more locations within or external to supply chain network 100, according to particular needs. In general, supply chain network 100 may operate to ultimately provide one or more items to one or more customers. As used herein, the word “item” includes products and services sold or made available by one or more entities of supply chain network 100, as well as raw materials or components that may be used in manufacturing processes of one or more entities of supply chain network 100, and the word “customer” includes both business or organizational clients, individual shoppers or consumers, as well as one or more supply chain entities 150 of supply chain network 100. The word “resource” refers to any vehicle, piece of equipment, person, robot or any other object used in supply chain network 100 or at one or more supply chain entities 150 to perform tasks or otherwise participate in supply chain execution. For example, skilled workers may be one kind of resource, while equipment such as forklifts or robotic machinery may be different kind of resource. Although one example of supply chain network 100 is shown and described, embodiments contemplate any configuration of supply chain networks 100 without departing from the scope of the present disclosure.

In one embodiment, resource orchestration system 110 comprises server 112 and database 114. Although resource orchestration system 110 is illustrated in FIG. 1 as comprising a single server 112 and a single database 114, embodiments contemplate resource orchestration system 110 including any suitable number of servers 112 or databases 114, serverless computing options, or data stores, internal to or externally coupled with resource orchestration system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores and/or other data storage systems, according to particular needs. As described in further detail below, resource orchestration system 110 comprises one or more modules to perform an end-to-end process for updating resource usage plans and resource usage tasks in response to detected changes in resource usage plans or changes or other unforeseen events detected during resource usage, such as the execution or performance of resource-related tasks. For example, a resource usage plan may be generated by resource orchestration system 110 or a separate system of supply chain network 100 for one of one or more supply chain entities 150, including connected or related supply chain entities, such as a truck yard or vehicle yard for a warehouse or distribution center. In such an example, resource orchestration system 110 may automatically detect required changes to the resource usage plans, such as changes required based on updated information about or relating to the warehouse and truck yard or other associated supply chain entities or updates to orders to be fulfilled by the warehouse and generate one or more tasks to implement the required changes as described in further detail below. In embodiments, resource orchestration system 110 may also detect changes to the execution of resource usage plans or deviations from normal resource usage and generate one or more tasks to implement the detected changes or to rectify the detected deviations.

Planning and execution system 120 comprises server 122 and database 124. Supply chain planning and execution is typically performed by several distinct and dissimilar processes, including, for example, demand forecasting, production planning, supply planning, distribution planning, execution, transportation management, warehouse management, fulfillment, procurement, and the like. Server 120 comprises one or more modules, such as, for example, a sourcing module, a scheduling module, and/or a pick-pack-ship module for performing one or more order fulfillment processes. Server 122 stores and retrieves data from database 124 or one or more locations in supply chain network 100. In addition, planning and execution system 120 may operate on one or more computers that are integral to or separate from the hardware and/or software that support warehouse tasking system 110, transportation network 130, archiving system 140 and one or more supply chain entities 150.

Transportation network 130 comprises server 132 and database 134. According to embodiments, transportation network 130 directs one or more delivery vehicles 136 to ship one or more items from one or more stocking locations of one or more supply chain entities 150 or customers of supply chain network 100. Transportation network 130 may direct one or more delivery vehicles 136 to and from vehicle yards or truck yards associated with one or more supply chain entities 150, such as yards associated with warehouses or distribution centers or yards associated with any other supply chain entity. A truck yard or vehicle yard may be any area or location suitable for the parking of one or more delivery vehicles 136 or any other vehicles of supply chain network 100 and may include one or more docks, doors, loading and unloading equipment, forklifts, machinery and/or any other resources or equipment needed to service and maintain one or more delivery vehicles 136 or any other vehicles of supply chain network 100. In embodiments, transportation network 130 directs one or more transportation vehicles 136 to ship one or more items inbound, for example, from one or more supply chain entities 150, including customers and/or suppliers 152, to one or more stocking locations. In embodiments, one or more delivery vehicles 136 may comprise a truck fleet used for performing deliveries, though one or more delivery vehicles 136 may include any manned, manually operated, unmanned, autonomous or remotely operated vehicles of any sort, including road vehicles, air vehicles or water vehicles. In addition, the number of items shipped by one or more delivery vehicles 136 in transportation network 130 may also be based, at least in part, on the number of items currently in stock at one or more stocking locations of one or more supply chain entities 150, the number of items currently in transit, a forecasted demand, a supply chain disruption, and the like. One or more delivery vehicles 136 comprise, for example, any number of trucks, cars, vans, boats, airplanes, unmanned aerial vehicles (UAVs), cranes, robotic machinery, or the like. According to embodiments, one or more delivery vehicles 136 may be associated with one or more supply chain entities 150 and may be directed by automated navigation including, for example, GPS guidance, according to particular needs.

Archiving system 140 comprises server 144 and database 146. Although archiving system 140 is shown as comprising a single server 144 and a single database 146, embodiments contemplate any suitable number of servers or databases internal to or externally coupled with archiving system 140. Server 144 may support one or more processes for receiving and storing data from planning and execution system 120 and/or one or more computers of supply chain network 100. According to some embodiments, archiving system 140 comprises an archive of data received from planning and execution system 120 and/or one or more computers of supply chain network 100. Archiving system 140 provides archived data to resource orchestration system 110 and/or planning and execution system 120. Server 142 may store the received data in database 144. Database 144 may comprise one or more databases or other data storage arrangements at one or more locations, local to, or remote from, the server.

One or more supply chain entities 150 may represent one or more suppliers 152, manufacturers 154, distribution centers 156 and retailers 158 in one or more supply chain networks, including one or more enterprises. Each of one or more supply chain entities 150 may comprise Internet of things (IOT) sensors, which may automatically transmit conditions (e.g., location, temperature, etc.) of any object to the fresh inventory system. The IoT sensors may transmit condition data periodically, e.g., every minute, every hour, every day, or may transmit condition data in response to a change, e.g., a door of a container being opened or closed.

One or more suppliers 152 may be any suitable entity that offers to sell or otherwise provides one or more items or components to one or more manufacturers. One or more suppliers 152 may, for example, receive an item from a first supply chain entity 150 in supply chain network 100 and provide the item to another supply chain entity 150. Items may comprise, for example, components, materials, products, parts, supplies, or other items, that may be used to produce products. In addition, or as an alternative, an item may comprise a supply or resource that is used to manufacture the item but does not become a part of the item. One or more suppliers 152 may comprise automated distribution systems 153 that automatically transport items to one or more manufacturers 154 based, at least in part, on a supply chain plan, a material or capacity reallocation, current and projected inventory levels, and/or one or more additional factors described herein.

One or more manufacturers 154 may be any suitable entity that manufactures at least one item. One or more manufacturers 154 may use one or more items during the manufacturing process to produce any manufactured, fabricated, assembled, or otherwise processed item, material, component, good, or product. In one embodiment, a product represents an item ready to be supplied to, for example, another one or more supply chain entities 150, such as one or more suppliers 152, an item that needs further processing, or any other item. One or more manufacturers 154 may, for example, produce and sell a product to one or more suppliers 152, another one or more manufacturers 154, distribution centers 156, retailers 158, a customer, or any other suitable entity. One or more manufacturers 154 may comprise automated robotic production machinery 155 that produce products based, at least in part, on a supply chain plan, a material or capacity reallocation, current and projected inventory levels, and/or one or more additional factors described herein.

One or more distribution centers 156 may be any suitable entity that offers to sell or otherwise distributes at least one product to one or more retailers 158 and/or customers. One or more distribution centers 156 may, for example, receive a product from a first supply chain entity 150 in supply chain network 100 and store and transport the product for a second supply chain entity 150. One or more distribution centers 156 may comprise automated warehousing systems 157 that automatically transport products to one or more retailers 158 or customers and/or automatically remove an item from, or place an item into, inventory based, at least in part, on a supply chain plan, a material or capacity reallocation, current and projected inventory levels, and/or one or more additional factors described herein.

One or more retailers 158 may be any suitable entity that obtains one or more products to sell to one or more customers. In addition, one or more retailers 158 may sell, store, and supply one or more components and/or repair a product with one or more components. One or more retailers 158 may comprise any online or brick and mortar location, including locations with shelving systems 159. Shelving systems 159 may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

Although one or more suppliers 152, manufacturers 154, distribution centers 156 and retailers 158 are shown and described as separate and distinct entities, the same supply chain entity 150 may simultaneously act as any other one or more suppliers 152, manufacturers 154, distribution centers 156 and retailers 158. For example, a particular manufacturer 154 acting as a manufacturer could produce a product, and manufacturer 154 could also act as a supplier 152 to supply a product to another one or more supply chain entities 150.

As shown in FIG. 1, supply chain network 100 comprising resource orchestration system 110, planning and execution system 120, transportation network 130, archiving system 140 and one or more supply chain entities 150 may operate on one or more computers, such as computer 160, that are integral to or separate from the hardware and/or software that support resource orchestration system 110, planning and execution system 120, transportation network 130, archiving system 140 and one or more supply chain entities 150. Computer 160 may include any suitable input device 162, such as a keypad, mouse, touch screen, microphone, or other device to input information. Output device 164 may convey information associated with the operation of supply chain network 100, including digital or analog data, visual information, or audio information. Computer 160 may include fixed or removable computer-readable storage media 166, including a non-transitory computer-readable medium, magnetic computer disks, flash drives, CD-ROM, in-memory device, or other suitable media to receive output from and provide input to supply chain network 100.

Computer 160 may include one or more processors and associated memory to execute instructions and manipulate information according to the operation of supply chain network 100 and any of the methods described herein. In addition, or as an alternative, embodiments contemplate executing the instructions on computer 160 that cause one or more other computers 160 to perform functions of the method. An apparatus implementing special purpose logic circuitry, for example, one or more field-programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations, local to, or remote from resource orchestration system 110, planning and execution system 120, transportation network 130, archiving system 140 and one or more supply chain entities 150. In addition, each computer 160 may be a workstation, personal computer (PC), network computer, notebook computer, tablet, personal digital assistant (PDA), cell phone, telephone, smartphone, augmented or virtual reality headset, or any other suitable computing device.

In one embodiment, resource orchestration system 110, planning and execution system 120, transportation network 130, archiving system 140, one or more supply chain entities 150 and computer 160 may be coupled with network 170 using one or more communication links 172-182, which may be any wireline, wireless, or other link suitable to support data communications between yard taking system 110, planning and execution system 120, transportation network 130, archiving system 140, one or more supply chain entities 150 and computer 160 and network 170 during operation of supply chain network 100. Although communication links 172-182 are shown as generally coupling resource orchestration system 110, planning and execution system 120, transportation network 130, archiving system 140, one or more supply chain entities 150 and computer 160 to network 170, any of resource orchestration system 110, planning and execution system 120, transportation network 130, archiving system 140, one or more supply chain entities 150 and computer 160 may communicate directly with each other, according to particular needs.

In another embodiment, network 170 includes the Internet and any appropriate local area networks (LANs), metropolitan area networks (MANs), or wide area networks (WANs) coupling resource orchestration system 110, planning and execution system 120, transportation network 130, archiving system 140, one or more supply chain entities 150 and computer 160. For example, data may be maintained locally too, or externally of, resource orchestration system 110, planning and execution system 120, transportation network 130, archiving system 140, one or more supply chain entities 150 and computer 160 and made available to one or more associated users of these systems using network 170 or in any other appropriate manner. For example, data may be maintained in a cloud database at one or more locations external to resource orchestration system 110, planning and execution system 120, transportation network 130, archiving system 140, one or more supply chain entities 150 and computer 160 and made available to one or more associated users of these systems using the cloud or in any other appropriate manner. Those skilled in the art will recognize that the complete structure and operation of network 170 and other components within supply chain network 100 are not depicted or described. Embodiments may be employed in conjunction with known communications networks and other components.

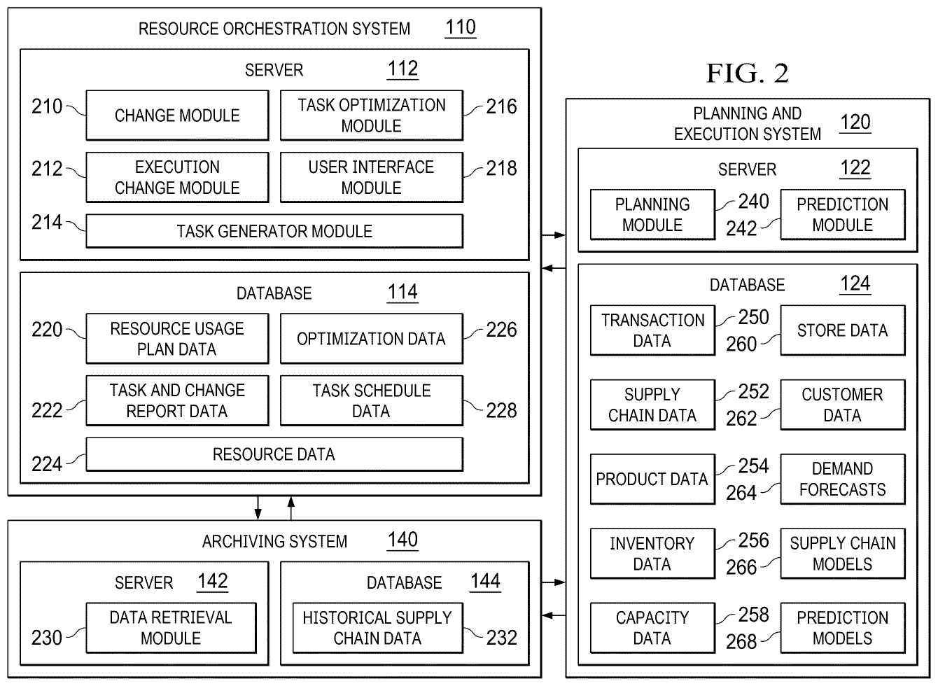

FIG. 2 illustrates resource orchestration system 110, planning and execution system 120 and archiving system 140 of FIG. 1 in greater detail in accordance with an embodiment. As discussed above, resource orchestration system 110 may comprise one or more computers at one or more locations within or external to supply chain network 100, including any associated input or output devices. Although resource orchestration system 110 is shown as comprising a single server 112 and a single database 114, embodiments contemplate any suitable number of computers, servers, or databases internal to, externally coupled with or remotely connected to resource orchestration system 110. According to some embodiments, resource orchestration system 110 may be located internal to a yard or associated supply chain entity such as a logistics hub, warehouse, distribution center or other supply chain entity 150, while in other embodiments, resource orchestration system 110 may be located external to a yard or other supply chain entity 150 and may be located in, for example, a headquarters of an entity or company operating a yard, according to particular needs.

Server 112 comprises change module 210, execution change module 212, task generator module 214, task optimization module 216 and user interface module 218. Although server 112 is illustrated and described as having several distinct and discrete modules performing various functions or tasks, embodiments contemplate the functions of server 112 and/or the various modules being performed by any number of software or hardware modules, applications or sub-routines including fewer than or more than the number of illustrated modules, according to needs. Although server 112 is illustrated and described as comprising a single change module 210, a single execution change module 212, a single task generator module 214, a single task optimization module 216 and a single user interface module 218, embodiments contemplate any suitable number or combination of these located at one or more locations, local to, or remote from resource orchestration system 110, such as on multiple servers or computers at any location in supply chain network 100.

Database 114 may comprise one or more databases or other data storage arrangements at one or more locations, local to, or remote from, server 112. Database 114 comprises, for example, resource usage plan data 220, task and change report data 222, resource data 224, optimization data 226 and task schedule data 228. Although database 114 is illustrated and described as comprising resource usage plan data 220, task and change report data 222, resource data 224, optimization data 226 and task schedule data 228, embodiments contemplate any suitable number or combination of these, located at one or more locations, local to, or remote from, resource orchestration system 110 according to particular needs. While the illustrated data is shown within a single database 114 for simplicity of explanation, in embodiments data may be stored separately either physically or logically for data security, data privacy, data integrity and confidentiality purposes.

In an embodiment change module 210 identifies changes in a resource usage plan based on resource usage plan report data. Resource usage plans may comprise schedules and/or allocations to tasks or work areas for equipment, labor and robot schedules for usage at one or more supply chain entities, which in some cases may share a pool of resources. For example, a warehouse and an associated nearby truck yard may share a pool of labor and equipment which may be allocated between the warehouse and the truck yard to perform tasks in both areas. In such a case, a resource usage plan for the warehouse and the truck yard may comprise a schedule for all of the shared resources including a set of tasks for each resource and a projected or scheduled start time and task duration for each of the set of tasks. A resource usage plan may be used during supply chain operations, to guide the performance of tasks or jobs such as inventory movement, truck loading, order packing or any other tasks or jobs that may be performed in a supply chain. Changes may be made to resource usage plans for several reasons, including increases, reductions or other changes in shipments to be made or orders to be fulfilled, changes in inventory to be replenished at one or more supply chain entities, scheduled equipment maintenance or projected equipment or labor unavailability or various other events that may occur during supply chain operations. To identify changes in resource usage plans, change module 210 may compare an initial resource usage plan with an updated or revised resource usage plan in order to identify changes from the initial resource usage plan to the updated resource usage plan.

In an embodiment execution change module 212 detects changes in supply chain processes and operations using real time data such as data obtained from cameras or other sensors located in or on one or more supply chain entities, as well as real-time task execution data and resource usage data. Execution change module 212 may detect changes such as resource conflicts or double-booking, incorrect matches between skills of resources and required tasks, equipment downtime or labor availability, robot navigation, resource idle periods due to synchronicity issues or other changes to task sequences and schedules. Any changes or issues detected by execution change module 212 may be used by task generator module 214 to generate tasks in response to such changes or issues.

In an embodiment task generator module 214 generates a set of tasks based on changes identified in resource usage plans or during supply chain execution. For example, task generator module 214 may associate each identified change with one or more tasks needed to execute the change, such as moving resources or inventory to different areas to accommodate updated usage schedules or any other tasks needed to implement changes in supply chain operations. In embodiments, resource orchestration system 110 may accept user input defining or limiting the scope of supply chain analysis. In such embodiments, task generator module 214 may limit the tasks produced based on the scope defined by the user and only generate a task list including tasks within the limited scope defined by the user. For example, if the user has limited the scope of the supply chain analysis to one shift of labor, task generator module 214 may only generate tasks related to that shift of labor.

In an embodiment task optimization module 216 determines a task priority for the tasks generated by task generator module 214 and further generates a task schedule for the tasks based on the task priority. Using information including resource capabilities and skills or capabilities of workers as well as real time data including resource locations, equipment or robot condition, task optimization module 216 may calculate a task cost associated with performing tasks in a particular sequence to determine a lowest-cost task sequence for the tasks. In embodiments, task cost may be defined as a time needed to complete a task sequence including the time needed to move between task locations. For example, if a resource usage plan includes using a particular forklift to load three trucks, with two vehicles located at adjacent dock doors and the third vehicle located at a distant dock door, loading the two vehicles at the adjacent dock doors consecutively will result in a faster task performance, and thus a lower task cost, than loading the third vehicle in between the two vehicles at the adjacent dock doors. In embodiments, task optimization module 216 may update the task schedule in real time based on changing conditions within supply chain entities, such as increased congestion along or near a particular areas of a supply chain entity, which would increase the time needed move vehicles or equipment though those areas. Task optimization module 216 may also dynamically re-determine task priority and task schedules based on task performance deviating from an initial task priority sequence. Task optimization module 216 may perform various sub-processes to determine an optimal task sequence and priority for a supply chain, including performing labor orchestration, equipment orchestration and robot and automation orchestration, as described in further detail below.

In an embodiment user interface module 218 generates and displays a user interface (UI), such as, for example, a graphical user interface (GUI), that displays resource usage plans, related tasks or any other data of resource orchestration system 110 in charts or graphs, or any other visual representations of data of resource orchestration system 110. According to embodiments, user interface module 218 displays a GUI comprising interactive graphical elements for selecting one or more resource usage plans and/or data of any kind stored in the database of resource orchestration system 110, and, in response to the selection, displaying the selected data on one or more display devices. User interface module 218 may generate interfaces for resource usage plans or related tasks to be performed and transmit the interfaces to devices associated with users, such as smartphones or tablets of employees or drivers. The users may then use the interfaces to assist in the performance of tasks according to a task schedule, such as a task schedule generated by task optimization module 216. In embodiments, user interface module 218 may generate non-visual interfaces, such as voice-based personal assistants or email messages or other text-based messages, and present resource data or resource usage plan data to customers over such voice-based or text-based interfaces.

In an embodiment resource usage plan data 220 comprises data of one or more resource usage plans or resource usage plan reports including but not limited to usage schedules for a pool of labor which may be subdivided into workers with different skill sets such as the ability to operate various equipment tor other skills, usage schedules for equipment such as machinery and vehicles and usage schedules for one or more robots or other pieces of automated machinery. Resource usage plan data 220 may include data of initial resource usage plans as well as data of changed or updated resource usage plans which include one or more changes due to received orders or any planning changes within supply chain network 100. In embodiments, resource usage plan data 220 may be retrieved from planning and execution system 120, archiving system 140 or from one or more supply chain entities 150. In embodiments, resource usage plan data 220 may be used by change module 210 to identify changes within resource usage plans.

In an embodiment task and change report data 222 comprises a list or report of all changes identified between an initial resource usage plan and a revised resource usage plan, as well as the tasks needed to execute the identified changes. For example, each change identified between resource usage plans will be associated with one or more tasks that will need to be implemented or executed in order to effectuate the change. In embodiments, task and change report data 222 may be generated by change module 210 and task generator module 214 and used by task optimization module 216 to determine a task sequence and task schedule for the tasks.

In an embodiment resource data 224 comprises data relevant to determining task priority for resources in use by or belonging to one or more supply chain entities. Resource data 224 may comprise information such as resource types and quantities, skills or capabilities of workers or other resources, equipment or vehicle age and/or condition, robot functionality, condition and capability or any other information related to resources. In embodiments, resource data 224 may include real-time data relating to the resources or associated supply chain entities that may be obtained from cameras or other sensors, including Internet of Things (IOT) sensors attached to or within one or more the supply chain entities or the resources. In embodiments, resource data 224 may be used by task optimization module 216 to determine a task sequence and task schedule for a set of tasks.

In an embodiment optimization data 226 comprises data generated during task optimization and scheduling. For example, optimization data 226 may include refinements or changes to resource usage plans or related tasks generated during tasks optimization such as optimal labor allocations, optimal equipment allocations and optimal robot allocations. Such refinements or changes may be generated to improve productivity of resources and associated supply chain entities, increase the flexibility of task allocations for resources, reduce the idle time, downtime and maintenance costs for equipment and robots and maximize return on investment for robots or other automations for the supply chain entities or for supply chain network 100 as a whole. In embodiments, optimization data 226 may be generated and used by task optimization module 216 to determine a task sequence and task schedule for a set of tasks.

In an embodiment task schedule data 228 comprises a schedule of tasks calculated to have a most efficient completion time for the set of tasks compared to all other possible schedules of the tasks. Task schedule data 228 may include one or more tasks, paths or sequences to travel for task performance, scheduled times for tasks, an estimate of total time required to perform the one or more tasks, information of any equipment needed to perform the one or more tasks and a total route cost for the one or more tasks. Task schedule data 228 may be displayed on devices associated with users of resource orchestration system 110 in order to allow the tasks to be performed according to the schedule of task schedule data 228. In embodiments, task schedule data 228 may be generated by task optimization module 216 and used by user interface module 218 to display task schedules or individual tasks to employees or workers of a supply chain entity.

As discussed above, planning and execution system 120 comprises server 122 and database 124. Although planning and execution system 120 is shown as comprising a single server 122 and a single database 124, embodiments contemplate any suitable number of servers 122 or databases 124 internal to or externally coupled with planning and execution system 120. Server 122 comprises planning module 240 and prediction module 242. Although server 122 is shown and described as comprising a single planning module 240 and a single prediction module 242, embodiments contemplate any suitable number or combination of planning modules 240 and prediction modules 242 located at one or more locations, local to, or remote from planning and execution system 120, such as on multiple servers or computers at one or more locations within or external to supply chain network 100.

Database 124 may comprise one or more databases or other data storage arrangements at one or more locations, local to, or remote from, server 122. Database 124 comprises, for example, transaction data 250, supply chain data 252, product data 254, inventory data 256, capacity data 258, store data 260, customer data 262, demand forecasts 264, supply chain models 266 and prediction models 268. Although database 124 is shown and described as comprising transaction data 250, supply chain data 252, product data 254, inventory data 256, capacity data 258, store data 260, customer data 262, demand forecasts 264, supply chain models 266 and prediction models 268, embodiments contemplate any suitable number or combination of data, located at one or more locations, local to, or remote from, planning and execution system 120, according to particular needs.

Planning module 240 works in connection with prediction module 242 to generate a plan based on one or more predicted retail volumes, classifications, or other predictions. By way of example and not of limitation, planning module 240 may comprise a demand planner that generates a demand forecast for one or more supply chain entities 150. Planning module 240 may generate the demand forecast, at least in part, from predictions and calculated factor values for one or more causal factors received from prediction module 242.

Prediction module 242 applies samples of transaction data 250, supply chain data 252, product data 254, inventory data 256, store data 260, customer data 262, demand forecasts 264 and other data to prediction models 268 to generate predictions for one or more supply chain entities 150. In embodiments, prediction module 242 predicts a volume Y (target) from a set of causal factors X along with causal factors strengths that describe the strength of each causal factor variable contributing to the predicted volume. According to some embodiments, prediction module 242 generates predictions at daily intervals. However, embodiments contemplate longer and shorter prediction phases that may be performed, for example, weekly, twice a week, twice a day, hourly, or the like.

In an embodiment transaction data 250, comprises order data, shipment data, recorded sales and returns transactions and related data, including, for example, a transaction identification, time and date stamp, channel identification (such as stores or online touchpoints), product identification, actual cost, selling price, sales volume, customer identification, promotions, and or the like. In addition, transaction data 250 is represented by any suitable combination of values and dimensions, aggregated or un-aggregated, such as, for example, sales per week, sales per week per location, sales per day, sales per day per season, or the like.

In an embodiment supply chain data 252 comprises any data of one or more supply chain entities 150 including, for example, item data, identifiers, metadata (comprising dimensions, hierarchies, levels, members, attributes, cluster information, and member attribute values), fact data (comprising measure values for combinations of members), business constraints, goals and objectives of one or more supply chain entities 150.

In an embodiment product data 254 comprises products identified by, for example, a product identifier (such as a Stock Keeping Unit (SKU), Universal Product Code (UPC) or the like), and one or more attributes and attribute types associated with the product ID. Product data 254 may comprise data about one or more products organized and sortable by, for example, product attributes, attribute values, product identification, sales volume, demand forecast, or any stored category or dimension. Attributes of one or more products may be, for example, any categorical characteristic or quality of a product, and an attribute value may be a specific value or identity for the one or more products according to the categorical characteristic or quality, including, for example, physical parameters (such as, for example, size, weight, dimensions, color, and the like).

In an embodiment inventory data 256 comprises any data relating to current or projected inventory quantities or states, order rules, or the like. For example, inventory data 256 may comprise the current level of inventory for each item at one or more stocking points or warehouses across supply chain network 100. In addition, inventory data 256 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 120 accesses and stores inventory data 256 in database 124, which may be used by planning and execution system 120 to place orders, set inventory levels at one or more stocking points, initiate manufacturing of one or more components, or the like.

In embodiments, inventory data 256 may further comprise one or more inventory policies. The inventory policies may comprise any suitable inventory policy describing the reorder point and target quantity, or other inventory policy parameters that set rules for planning and execution system 120 to manage and reorder inventory. The inventory policies may be based on target service level, demand, cost, fill rate, or the like. According to embodiments, the inventory policies comprise target service levels that ensure that a service level of one or more supply chain entities 150 is met with a set probability. For example, one or more supply chain entities 150 may set a service level at 95%, meaning supply chain entities will set the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 120 may determine a replenishment order according to one or more replenishment rules, which, among other things, indicates to one or more supply chain entities 150 to determine or receive inventory to replace the depleted inventory. By way of example only and not by way of limitation, an inventory policy for non-perishable goods with linear holding and shorting costs may comprise a min./max. (s,S) inventory policy. Other inventory policies may be used for perishable goods, such as fruit, vegetables, dairy, fresh meat, as well as electronics, fashion, and similar items for which demand drops significantly after a next iteration of a product is released.

In an embodiment capacity data 258 comprises any data relating to current or projected resource capacity values or states, order rules, or the like. For example, capacity data 258 may comprise the current level of capacity for each task at one or more locations across supply chain network 100. In addition, capacity data 258 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 120 accesses and stores capacity data 258 in database 124, which may be used by planning and execution system 120 to place orders, set capacity levels at one or more locations in supply chain network 100, initiate manufacturing of one or more components, or the like.

In embodiments, capacity data 258 may further comprise one or more capacity policies. The capacity policies may comprise any suitable capacity policy describing the reorder point and target quantity, or other capacity policy parameters that set rules for planning and execution system 120 to manage capacity. The capacity policies may be based on target service level, demand, cost, or the like. According to embodiments, the capacity policies comprise target service levels that ensure that a service level of one or more supply chain entities 150 is met with a set probability. For example, one or more supply chain entities 150 may set a service level at 95%, meaning supply chain entities will set the desired capacity level at a level that meets demand 95% of the time.

In an embodiment store data 260 comprises data describing the physical retail stores of one or more retailers and related store information. Store data 260 may comprise, for example, a store ID, store description, store location details, store location climate, store type, store opening date, lifestyle, store area (expressed in, for example, square feet, square meters, or other suitable measurement), latitude, longitude, store layouts, employee data for stores, planograms for merchandising with the store and other similar data.

In an embodiment customer data 262 comprises customer identity information, including, for example, customer relationship management data, loyalty programs, and mappings between product purchases and one or more customers so that a customer associated with a transaction may be identified. Customer data 262 may comprise data relating customer purchases to one or more products, geographical regions, store locations, or other types of dimensions.

In an embodiment demand forecasts 264 comprise any data produced as part of a demand forecast process and may indicate future expected demand based on, for example, any data relating to past sales, past demand, purchase data, promotions, events, or the like of one or more supply chain entities 150. Demand forecasts 264 may cover a time interval such as, for example, by the minute, hour, daily, weekly, monthly, quarterly, yearly, or any other suitable time interval, including substantially in real time. Demand may be modeled as a negative binomial or Poisson-Gamma distribution. According to other embodiments, the model also takes into account shelf-life of perishable goods (which may range from days (e.g. fresh fish or meat) to weeks (e.g. butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors.

In an embodiment supply chain models 266 comprise models which describe the characteristics of a supply chain or supply chain network, such as supply chain network 100, including a setup to deliver the customer expectations or a particular customer business model. These characteristics may comprise differentiating factors, such as, for example, MTO (Make-to-Order), ETO (Engineer-to-Order) or MTS (Make-to-Stock). However, supply chain models 266 may also comprise characteristics that specify the supply chain structure in even more detail, including, for example, specifying the type of collaboration with the customer (e.g. Vendor-Managed Inventory (VMI)), from where products may be sourced, and how products may be allocated, shipped, or paid for, by particular customers. Each of these characteristics may lead to a different supply chain model.

In an embodiment prediction models 268 comprise one or more trained artificial intelligence (AI) or machine learning (ML) models used by planning and execution system 120 for predicting, among other variables, pricing, targeting, or retail volume, such as, for example, a forecasted demand volume for one or more products at one or more stores of one or more retailers based on the prices of the one or more products.

As discussed above, archiving system 140 comprises server 142 and database 144. Although archiving system 140 is shown as comprising a single server 142 and a single database 144, embodiments contemplate any suitable number of servers 142 or databases 144 internal to or externally coupled with archiving system 140. Server 142 comprises data retrieval module 230. Although server 142 is shown and described as comprising a single data retrieval module 230, embodiments contemplate any suitable number or combination of data retrieval modules located at one or more locations, local to, or remote from archiving system 140, such as on multiple servers or computers at one or more locations in supply chain network 100.

Database 144 may comprise one or more databases or other data storage arrangements at one or more locations, local to, or remote from, server 142. Database 144 comprises, for example, historical supply chain data 232. Although database 144 is shown and described as comprising historical supply chain data 232, embodiments contemplate any suitable number or combination of data, located at one or more locations, local to, or remote from, archiving system 140, according to particular needs.

In one embodiment, data retrieval module 230 receives historical supply chain data 232 from planning and execution system 120 or one or more supply chain entities 150 and stores the received historical supply chain data in database 144. According to one embodiment, data retrieval module 230 may prepare historical supply chain data 232 for use by checking historical supply chain data 232 for errors and transforming historical supply chain data 232 to normalize, aggregate, and/or rescale historical supply chain data 232 to allow direct comparison of data received from different planning and execution systems 120 or different supply chain entities 150. In embodiments, data retrieval module 230 may retrieve data from one or more sources external to supply chain network 100, such as, for example, weather data, special events data, social media data, calendar data, and the like and stores the received data as historical supply chain data 232.

Historical supply chain data 232 comprises historical data received from resource orchestration system 110, planning and execution system 120, one or more supply chain entities 150, computer 160 or any other entity or device of supply chain network 100. Historical supply chain data 232 may comprise, for example, weather data, special events data, social media data, calendar data, and the like. In an embodiment, historical supply chain data 232 may comprise, for example, historic order data, shipment data and return data. In an embodiment, historical supply chain data 232 may comprise, for example, historic sales patterns, prices, promotions, weather conditions and other factors influencing future demand of the number of one or more items sold in supply chain network 100 over a time period, such as, for example, one or more days, weeks, months, years, including, for example, a day of the week, a day of the month, a day of the year, week of the month, week of the year, month of the year, special events, paydays or any other time period.

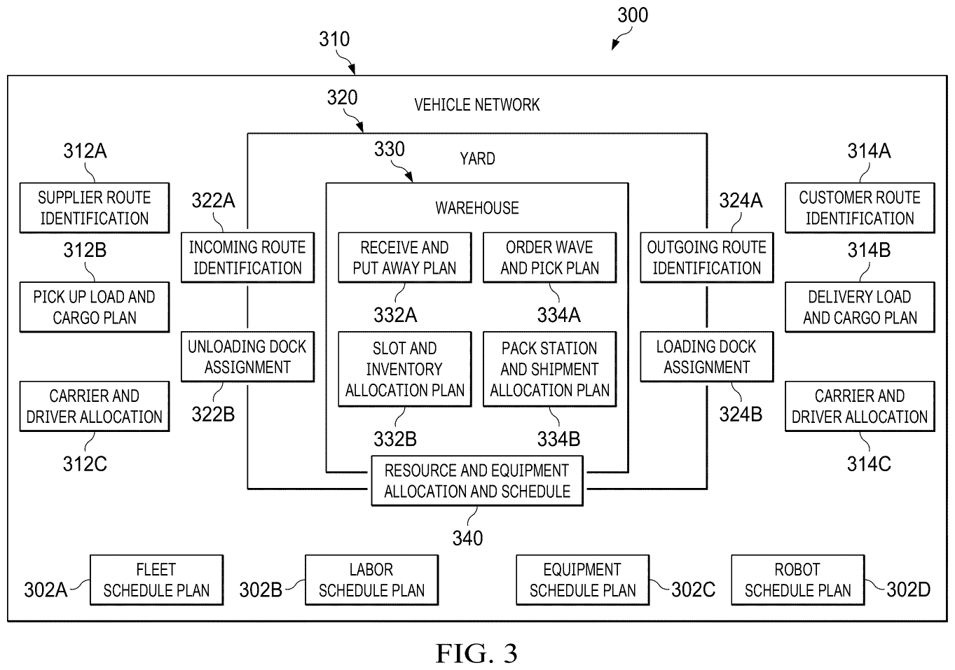

FIG. 3 illustrates example resource orchestration network 300, according to an embodiment. Resource orchestration network 300 includes vehicle network 310, yard 320, a vehicle yard or truck yard and warehouse 330, a warehouse or distribution center associated with and located adjacent or near to yard 320. Resource orchestration network 300 further includes one or more resources, such as human resources such as labor or workers, equipment or vehicle resources and robot or other automations resources. Resource orchestration network 300 includes various resource usage plans and usage schedules for the resources of resource orchestration network 300, such as fleet schedule plan 302A, labor schedule plane 302B, equipment schedule plan 302C and robot schedule plan 302D.

Resource orchestration network 300 has access to various transportation inbound data, including supplier route identification 312A, pick up load & cargo plan 312B and carrier & driver allocation 312C, which allow resource orchestration system 110 associated with resource orchestration network 310 to determine resource needs and requirements for inbound transportation tasks, such as scheduling and driving inbound vehicles to yard 320. Resource orchestration network 310 further has access to various transportation outbound data, including customer route identification 314A, delivery load & cargo plan 314B and carrier & driver allocation 314C, which allow resource orchestration system 110 to determine resource needs and requirements for outbound transportation tasks, such as scheduling and driving outbound vehicles from yard 320.

Resource orchestration network 300 has access to various yard inbound data, including incoming route identification 322A and unloading dock assignment 322B, which allow resource orchestration system 110 to determine resource needs and requirements for inbound yard tasks, such as maneuvering and unloading inbound vehicles within yard 320. Resource orchestration network 310 further has access to various yard outbound data, including outgoing route identification 324A and loading dock assignment 324B, which allow resource orchestration system 110 to determine resource needs and requirements for outbound yard tasks, such as maneuvering and loading outbound vehicles to leave yard 320.

Resource orchestration network 300 has access to various warehouse inbound data, including receive & put away plan 332A and slot & inventory allocation plan 332B, which allow resource orchestration system 110 to determine resource needs and requirements for inbound warehouse tasks, such as moving and putting away orders unloaded from inbound trucks. Resource orchestration network 310 further has access to various warehouse outbound data, including order wave & pick plan 334A and pack station & shipment allocation plan 334B, which allow resource orchestration system 110 to determine resource needs and requirements for outbound warehouse tasks, such as moving and packing orders to be loaded onto outbound trucks.

Resource orchestration system 110 may use the information and data of resource orchestration network 300 to generate resource & equipment allocation and schedule 340, which may include updates to the static resource usage plans and resource schedules of fleet schedule plan 302A, labor schedule plane 302B, equipment schedule plan 302C and robot schedule plan 302D, such as by using real-time execution data and resource status data obtain from vehicle network 310, yard 320 and warehouse 330.

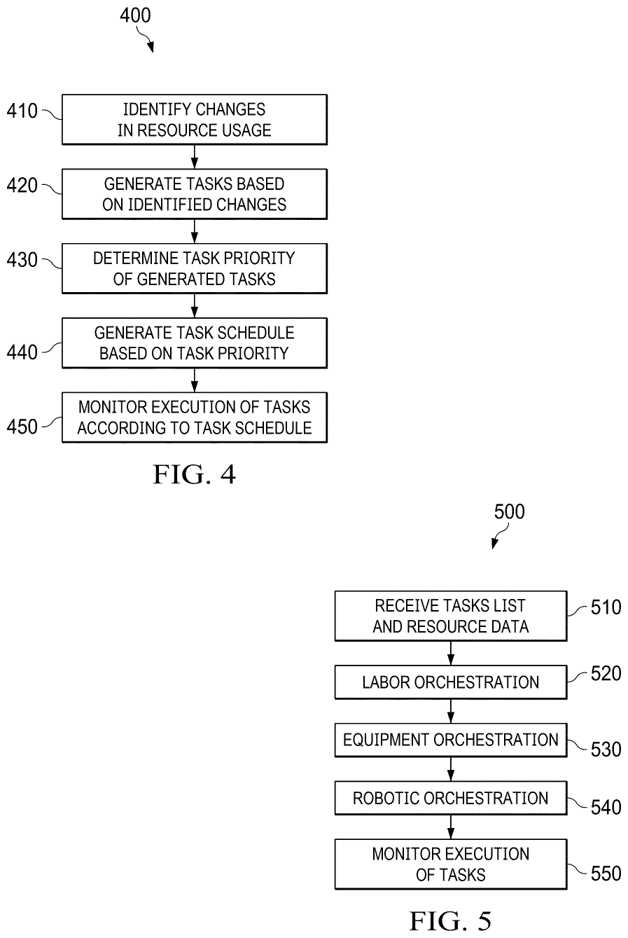

FIG. 4 illustrates example method 400 for generating and scheduling resource usage tasks, according to an embodiment. Method 400 may be performed by a resource orchestration system, such as resource orchestration system 110 of FIG. 1. Method 400 proceeds by one or more activities 410-450, which although described in a particular order may be performed in one or more permutations, combinations, orders, or repetitions, according to particular needs.

At first activity 410 resource orchestration system 110 identifies changes in a resource usage plan for supply chain network 100. For example, resource orchestration system 110 may compare an initial resource usage plan with a changed or updated resource usage plan to identify changes between the initial resource usage plan and the updated resource usage plan. As described in further detail above, changes may include changes to vehicle or equipment maintenance schedules, changes to labor assignments, planning changes of supply chain network 100 such as changed fulfillment or replenishment plans or any other change detected between resource usage plans. In embodiments, resource orchestration system 110 may also identify changes in supply chain execution based on real-time data captured via cameras or other sensors of supply chain network 100, such as unplanned unavailability or limited functionality of vehicles, equipment or labor, although other possible execution changes are described in further detail above.

At second activity 420 resource orchestration system 110 generates tasks based on the changes identified at first activity 410. In general, yard changes may require a set of tasks in order to be implemented fully. For example, if one resource usage change includes an equipment failure for one of three forklifts used by a warehouse and associated vehicle yard, tasks required to implement that change may include updating the usage schedules for the unavailable forklift as well as the remaining available forklifts, updating work schedules for any workers associated with the unavailable forklift to perform other work while the forklift is repaired or any other changes necessary to update warehouse and yard execution to account for the available forklift. Although a simplified example is presented here for ease of explanation, in practice actual resource usage changes may require many more tasks to be fully implement, even when the total number of changes is low.

At third activity 430 resource orchestration system 110 determines a task priority of the tasks generated at second activity 420. To maximize efficiency of task performance, resource orchestration system 110 may use various data streams, including real-time data captured via sensors of supply chain network 100, to determine a task sequence that can be performed as quickly as possible or in as few steps as possible for users. For example, if a set of tasks take place across several different docks within a vehicle yard, the task priority determined for the set of tasks would be organized for each task to be performed in sequence of physical distance, instead of a pattern that takes the user back and forth between docks that are far apart.

At fourth activity 440 resource orchestration system 110 generates a task schedule based on the task priority generated at third activity 430. Because resource tasks or jobs frequently involve resources used in different physical areas, a schedule for resource usage can greatly increase the efficiency of task performance by effectively allocating the usage of resources in a way that minimizes travel distance for the resources. Resource orchestration system 110 may utilize real-time resource utilization and condition data to determine the availability of resources, such as the current and expected location of vehicles, which in turn can be used to generate a dynamic task schedule for supply chain network 100. In embodiments, the dynamic task schedule may be updated during execution in order to adjust to execution changes, such as breakdowns or loss of functionality in the resources.

At fifth activity 450 resource orchestration system 110 monitors execution of the tasks generated at second activity 420 according to the task schedule determined at fourth activity 440. Resource orchestration system 110 may monitor execution in real time via devices associated with supply chain network 100, including cameras or other sensors installed in or on vehicles or buildings, as well as devices associated with employees or drivers including smartphones, tablets or other devices, such as IoT devices, that can transmit location data. In embodiments, if a task is performed out of sequence or out of schedule, or a task that was not in the set of tasks was performed, or the user has otherwise deviated from the task schedule, resource orchestration system 110 may perform dynamic re-sequencing and dynamic re-scheduling to account for the deviation. Resource orchestration system 110 may then transmit an updated task schedule to the devices associated with the employees or drivers. In embodiments, the resource orchestration system 110 may perform dynamic re-scheduling in real time to account for deviations in task schedule and transmit in real time an updated task schedule. For example, if an error occurs by a user executing a task, the resource orchestration system 110 may detect the error in real time and transmit in real time one or more tasks to a mobile device of the user to account for the error. Resource orchestration system 110 may monitor execution of the tasks and send new task schedules as needed, until all tasks of the task schedule have been performed.

FIG. 5 illustrates example method 500 for resource orchestration, according to an embodiment. Method 500 may be performed by a resource orchestration system, such as resource orchestration system 110 of FIG. 1. Method 500 proceeds by one or more activities 510-550, which although described in a particular order may be performed in one or more permutations, combinations, orders, or repetitions, according to particular needs.

At first activity 510 resource orchestration system 110 receives a task list and resource data associated supply chain network 100. As described in further detail above, the task list may be generated by resource orchestration system 110 based on a set of changes detected by comparing initial and updated resource usage plans, or by detecting changes in supply chain execution using real-time data. The resource data may include schedule arrival times of vehicles at one or more supply chain entities 150, robot and equipment availability and location at one or more supply chain entities 150 and available labor pool including skills of the labor pool and shift times or schedules at one or more supply chain entities. Resource orchestration system 110 may also receive data on all inbound and outbound orders of supply chain network 100 including SKUs of orders, urgency of orders and expected or projected SLA associated with orders.

At second activity 520 resource orchestration system 110 performs optimal labor orchestration for supply chain network 100. To perform optimal labor orchestration, resource orchestration system 110 may match task requirements of outstanding tasks with labor skill profiles of available labor, determine what skills may be transferrable or cross-trained with other skills, such as picking and put-away skills likely being transferrable for most labor and dynamically reallocate tasks to labor based on workload of labor and risk of SLA breach risk.

At third activity 530 resource orchestration system 110 performs optimal equipment orchestration for supply chain network 100. To perform optimal equipment orchestration, resource orchestration system 110 may check equipment health and maintenance schedules, allocate outstanding tasks to equipment based on task suitability, such as assigning forklifts with long forks to orders with large-sized SKUs, and maximize the multipurpose uses of equipment such as assigning forklifts to locations where docking and storage tasks are needed.

At fourth activity 540 resource orchestration system 110 performs optimal robotic orchestration for supply chain network 100. To perform optimal robot orchestration, resource orchestration system 110 may determine human-robot collaboration requirements, allocate collaborative robots to workers and schedule robots such as automated guided vehicles (AGVs) for truck movement or restocking tasks within supply chain network 100.

At fifth activity 550 resource orchestration system 110 monitors execution of the tasks allocated to resources at second through fourth activities 520-540. Resource orchestration system 110 may monitor the execution of allocated tasks in real time via devices associated with supply chain network 100, including via cameras or devices associated with employees or drivers including smartphones, tablets or other sensors, such as IoT devices, that can transmit location data. In embodiment, resource orchestration system 110 may track various key performance indicators (KPIs) for the resources including utilization time, idle time and delays, and reassigning tasks in real time to account for detected or predicted SLA breaches or unexpected downtime or other unavailability of resources. As described in further detail above, resource orchestration system 110 may perform dynamic re-sequencing and dynamic re-scheduling to account for any deviations in allocated tasks.

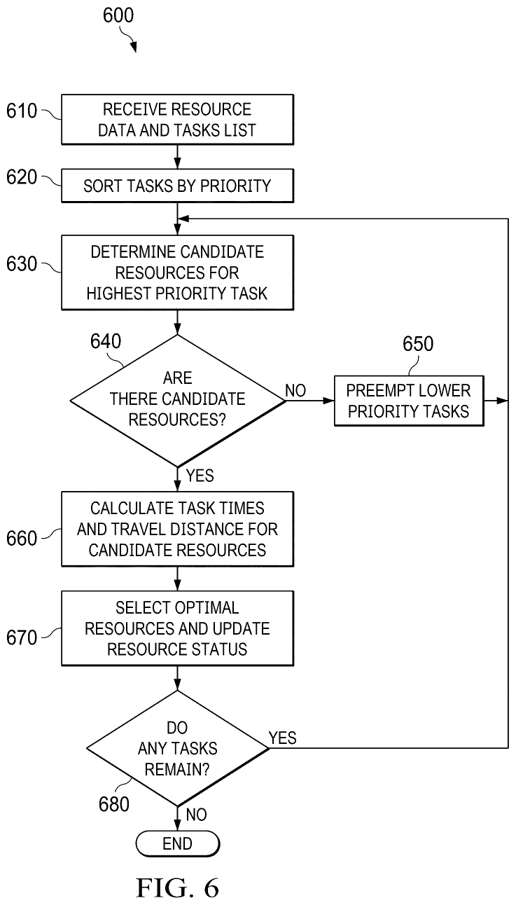

FIG. 6 illustrates example method 600 for assigning resources to tasks, according to an embodiment. Method 600 may be performed by a resource orchestration system, such as resource orchestration system 110 of FIG. 1. Method 600 proceeds by one or more activities 610-680, which although described in a particular order may be performed in one or more permutations, combinations, orders, or repetitions, according to particular needs.

At first activity 610 resource orchestration system 110 receives resource status and a tasks list for supply chain network 100 or for a subset of supply chain entities 140 in supply chain network 100. For example, resource status may indicate availability or unavailability of resources such as equipment and resources or shift schedules and workload for human resources. The task list may include a listing of all tasks to be performed by supply chain network 100 or for the subset of supply chain entities 140 in supply chain network 100, which may include any supply chain execution tasks such as picking, packing or shipping orders, equipment maintenance or any other movement, repackaging or any other task that may be performed by or to resources of supply chain network 100.

At second activity 620 resource orchestration system 110 sorts tasks of the task list according to determined priority for the tasks. Priority for the tasks may be determined by a number of factors, including when a task was received or created, the size or value of an order associated with a task, an assigned urgency or priority score for a task or a determined SLA urgency for a task, such as an imminent completion deadline in order to meet an SLA for an order associated with the task.

At third activity 630 resource orchestration system 110 determines candidate resources for a highest priority task as determined by the task priority determined at second activity 620. To determine candidate resources, resource orchestration system 110 may verify that the task can be completed by or with a certain resource based on task characteristics including required skills to perform a task for human resources, equipment suitability to perform a task for equipment resources or robot applicability to a task for robotic resources. In embodiments, in addition to resource suitability for a certain task, resource orchestration system 110 may also use the resource status received at first activity 610 to verify that a particular resource is available to be assigned to the highest priority task. In embodiments, the candidate resources may comprise sets of candidate resources for tasks requiring more than one resource. For example, a task to move a pallet of inventory may require at least two resources, a human forklift operator and a suitable forklift, although other supply chain execution tasks may require additional resources or as few as one resource, according to needs. In embodiments, resource orchestration system 110 may utilize one or more machine learning (ML) or artificial intelligence (AI) models to match tasks to candidate resources or to determine resource suitability for a particular task. For example, the one or more ML or AI models may determine whether a particular employee with a packing skills may be able to perform some packing tasks based on previous performance of the employee in non-packing tasks.

At fourth activity 640 resource orchestration system 110 determines if any candidate resources of sets of candidate resources were identified for the highest priority task at third activity 630. If there are no candidate resources for the highest priority task, method 600 proceeds to fifth activity 650, where resource orchestration system 110 preempts lower priority tasks to free up already assigned resources to the highest priority task. For example, resource orchestration system 110 may score the priority and urgency of already assigned or already scheduled tasks within supply chain network 110 to determine if any already assigned or already scheduled tasks have a lower priority than the highest priority task. If so, may reschedule any lower priority tasks and change the availability status of the associated resources. Method 600 then returns to third activity 630 where candidate resources for the highest priority task will be determined when considering the resources that have been made available at fifth activity 650. In embodiments, if resource orchestration system 110 determines there are no lower priority tasks to preempt, resource orchestration system 110 may enter a waiting period or place the highest priority task on a waiting list until resources become available to be assigned to the highest priority task.

If, however, at fourth activity 640 there are candidate resources for the highest priority task, method 600 proceeds to sixth activity 660 resource orchestration system 110 calculates task times and travel distances for the candidate resources determined at third activity 630. Resource orchestration system 110 may use the calculated task times and travel distances to determine a resource optimality score for each candidate resource or set of candidate resource, which may represent the overall efficiency or optimality of using a particular candidate resource or set of candidate resources for performing the highest priority task.

At seventh activity 670 resource orchestration system 110 selects optimal resources for the highest priority task based on the optimality score for the candidate resources determined at sixth activity 660 and updates the resource status for the selected resources to be unavailable. Doing so prevents the selected resources from being considered as candidate resources for subsequent tasks.

At eighth activity 680 resource orchestration system 110 determines if any tasks from the task list received at first activity 610 remain to receive resource assignments. If there are no tasks remaining, method 600 ends. If, however, there are tasks remaining, then method 600 returns to third activity 630, where resource orchestration system 110 determines candidate resources for a next-highest priority task. Method 600 may continue in this loop of activities 630-670 until all tasks of the task list have been assigned resources.

To further explain the operation of method 600, please consider the following example scenario. Warehouse A in supply chain network 100 has resources including five workers skilled in picking tasks, three of whom are also skilled in put-away tasks. Warehouse A also has three forklifts, one of which is schedule for maintenance in one hour, and four robots including two picking robots and AGVs for transportation internal to Warehouse A. Warehouse A has three urgent outbound orders to be picked outstanding, with an SLA breach possible if not picked in 20 minutes, two restocking jobs requiring put-away skills and one pallet movement job requiring an AGV and a human loader. At first activity 610, resource orchestration system 110 associated with Warehouse A receives a task list comprising the three outbound orders, the two restocking jobs and the one pallet movement job, and resource statuses for the Warehouse A resource indicating that one of the forklifts is unavailable due to maintenance. At second activity 620, resource orchestration system 110 sorts the tasks of the task list by priority and determines that the three outbound orders are more urgent due to the SLA requiring picking in the next twenty minutes and should have resources assigned first.

At third activity 630, resource orchestration system 110 determines that the three skilled pickers are candidate resources for the urgent picking tasks requiring picking in the next 20 minutes, and at sixth activity 660 calculates task times for the three skilled pickers. At seventh activity 670, resource orchestration system 110 assigns each picker to one picking job based on the calculated task times. Resource orchestration system 110 further assigns the two forklifts not scheduled for maintenance to the restocking jobs, as the restocking jobs involve heavy SKUs that may damage the forklift requiring maintenance. Resource orchestration system 110 then also assigns one of the skilled pickers who is cross-trained with put-away skills and one of the AGVs to the pallet movement task. Resource orchestration system 110 then determines that the remaining picker and the remaining AGV will be idle, and so determines to allocate those idle resources to another task in Warehouse A in order to reduce total idle time for the resources.

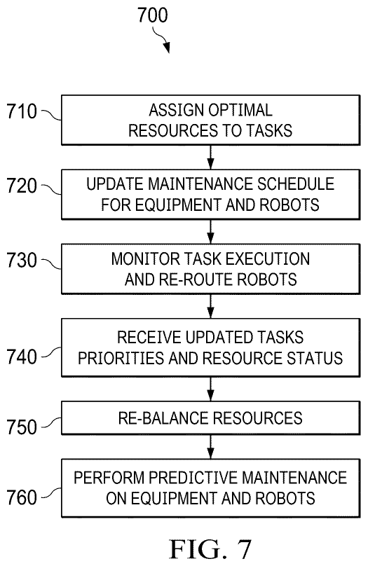

FIG. 7 illustrates example method 700 for rebalancing resource allocation, according to an embodiment. Method 700 may be performed by a resource orchestration system, such as resource orchestration system 110 of FIG. 1. Method 700 proceeds by one or more activities 710-760, which although described in a particular order may be performed in one or more permutations, combinations, orders, or repetitions, according to particular needs.

At first activity 710 resource orchestration system 110 assigns optimal resources to tasks for supply chain network 100 or for a subset of supply chain entities 140 in supply chain network 100. In embodiments, resource orchestration system 110 may utilize a method such as method 600 above to assign optimal resources to tasks.

At second activity 720 resource orchestration system 110 updates maintenance schedules for equipment and robot resources of supply chain network 100 based on the optimal task assignments of first activity 710. For example, resource orchestration system 110 that performance of a certain task or a certain number of tasks may require sooner maintenance than originally scheduled, or may determine that a particular task has a high likelihood of creating a maintenance issue, such as a task requiring a further than usual travel distance or a task requiring the movement of a heavier or larger than usual amount of inventory.

At third activity 730 resource orchestration system 110 monitors task execution of the tasks assigned at first activity 710 and may re-route robots assigned to certain travel paths based on real time data of supply chain network 100 or one or more supply chain entities 140. For example, resource orchestration system 110 may determine, during monitoring of task execution, that a particular aisle of a warehouse has become congested due to equipment in the aisle. In such a case, resource orchestration system 110 may re-route robots performing tasks in the warehouse around that aisle, so as to improve robot transit speed and reduce congestion in the aisle and overall congestion in the warehouse.

At fourth activity 740 resource orchestration system 110 receives updates task priorities and resource statuses for supply chain network 100. For example, as described in further detail above, one more IOT or other sensors attached to the resources or located within supply chain entities 140 may continuously provide real-time data to resource orchestration system 110 which may be used to update resource status. In embodiments, resource orchestration system 110 may also receive new orders or changes to existing orders within supply chain network 100 and use the new orders or the changes to existing orders to update task priorities.

At fifth activity 750 resource orchestration system 110 re-balances resources of supply chain network 100 based on the updated task priorities and resources status received at fourth activity 740. For example, if a particular task had been assigned low priority and subsequently been placed on a resource wait list awaiting resource availability but afterwards an update to an order corresponding to the task indicates urgent performance before SLA violation, then resource orchestration system 110 may update the priority for the task, preempt lower priority tasks to free up resources and assign the best available resources to the task to ensure task performance before the SLA violation occurs. In embodiments, to re-balance the resources, resource orchestration system may utilize a method such as method 600 described in further detail above.

At sixth activity 760 resource orchestration system 110 performs predictive maintenance on the equipment and robots of supply chain network 110 based on the updated maintenance schedules determined at second activity 720 and the updates resource statuses received at fourth activity 740. Resource orchestration system 110 may determine to perform predictive maintenance on resources when resources are idle or otherwise currently in downtime windows in order to reduce disruption to task performance of supply chain network 100. In embodiments, resource orchestration system 110 may utilize one or more machine learning (ML) or artificial intelligence (AI) models to match tasks to determine when predictive maintenance should be performed. For example, the one or more ML or AI models may determine, based on resource usage patterns and resource task performance when maintenance to resources may be required or beneficial before scheduled maintenance occurs. In embodiments, predictive maintenance may improve resource performance, reduce resource downtime and reduce the costs of resource maintenance and repair by preventing resource breakdowns.

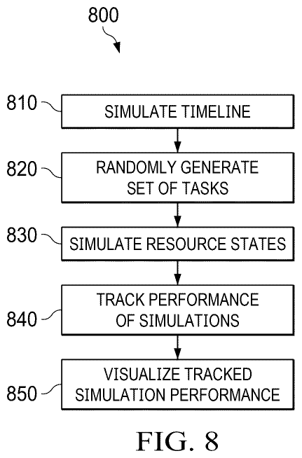

FIG. 8 illustrates an example method for resource orchestration simulation, according to an embodiment. Method 800 may be performed by a resource orchestration system, such as resource orchestration system 110 of FIG. 1. Method 800 proceeds by one or more activities 810-850, which although described in a particular order may be performed in one or more permutations, combinations, orders, or repetitions, according to particular needs.

At first activity 810 resource orchestration system 110 simulates a timeline of resource usage for supply chain network 100. In embodiments, resource orchestration system 110 may vary the length of time of a timeline to simulate, such as simulating a single 8-hour shift for a labor pool, simulating an entire day for a particular supply chain entity or simulating longer or shorter periods as necessary for one or more supply chain entities of supply chain network 100.

At second activity 820 resource orchestration system 110 randomly generates a set of tasks for the timeline simulation at first activity 810. In embodiments, resource orchestration system 110 may generate tasks with varying priorities and SLA requirements, such as by associating the generated tasks with one or more simulated orders to be fulfilled within a particular timeframe within the simulated timeline. Resource orchestration system 110 may generate tasks with varying priorities in order to determine a sequence that the tasks should be performed in during the simulation.

At third activity 830 resource orchestration system 110 simulates resource states for a set of simulated resources associated with the set of tasks generated at second activity 820. For example, resource orchestration system 110 may simulate busy and available states for the resources as well as maintenance or cool-down periods or windows for the resources. In embodiments, the set of simulated resources may correspond to a set of actual resources belonging to or assigned to a supply chain entity or set of supply chain entities, such as the workers, vehicles, equipment and robots that may be assigned to a particular joined warehouse and vehicle yard.

At fourth activity 840 resource orchestration system 110 tracks performance of the simulated resources within the simulations by simulating the performance of resources when performing the tasks generated at second activity 820. In embodiments, resource orchestration system 110 may simulate task performance according to a set task or resource usage plan or schedule, as described in further detail above. Performance of the simulated resources may be tracked by various metrics including utilization percentage, average task wait time and a count of the number, if any, of SLA breaches.

At fifth activity 850 resource orchestration system 110 visualizes the simulation performance tracked at fourth activity 840. For example, resource orchestration system 110 may generate and display to a user, via user interface module 218, one or more charts or logs of the metrics tracked at fourth activity 850. Visualization of the simulation performance may enable users of resource orchestration system 110 to easily see and understand the projected or expected performance of resources based on a current resource usage or supply chain plan.

In this example, compared to existing supply chain execution systems, the use of resource orchestration system 110 results in high utilization and more flexible deployment of labor, lower maintenance costs and better uptime for equipment, reduced human fatigue and faster throughput for workers collaborating with robots or automations and overall streamlined resource flows and better returns on investment for Warehouse A and supply chain network 100.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for generating and scheduling resource usage tasks, comprising:
a computer comprising a processor and memory and configured to:
identify changes in a resource usage plan within a supply chain network;
generate tasks based on the identified changes;
determine a task priority of the generated tasks;
generate a task schedule based on the determined task priority; and
monitor real time execution of the generated tasks according to the task schedule.

2. The system of claim 1, wherein the monitoring is performed via devices associated with the supply chain network.

3. The system of claim 1, wherein the monitoring is performed by cameras or other sensors in the supply chain network.

4. The system of claim 1, wherein the task schedule allocates usage of equipment and vehicles.

5. The system of claim 1, wherein the computer is further configured to:
perform, in real time, dynamic re-sequencing and dynamic re-scheduling to account for a deviation from the schedule.

6. The system of claim 1, wherein the computer is further configured to:
detect, in real time, an error and transmit, in real time, one or more tasks to a mobile device to account for the detected error.

7. The system of claim 1, wherein the computer is further configured to:
update the task schedule during execution of the task schedule to adjust for breakdowns or loss of functionality in resources.

8. A method for generating and scheduling resource usage tasks, comprising:
identifying, by a computer comprising a processor and memory, changes in a resource usage plan within a supply chain network;
generating, by the computer, tasks based on the identified changes;
determining, by the computer, a task priority of the generated tasks;
generating, by the computer, a task schedule based on the determined task priority; and
monitoring, by the computer, real time execution of the generated tasks according to the task schedule.

9. The method of claim 8, wherein the monitoring is performed via devices associated with the supply chain network.

10. The method of claim 8, wherein the monitoring is performed by cameras or other sensors in the supply chain network.

11. The method of claim 8, wherein the task schedule allocates usage of equipment and vehicles.

12. The method of claim 8, further comprising:
performing, by the computer in real time, dynamic re-sequencing and dynamic re-scheduling to account for a deviation from the schedule.

13. The method of claim 8, further comprising:
detecting, by the computer, an error in real time and transmit, in real time, one or more tasks to a mobile device to account for the detected error.

14. The method of claim 8, further comprising:
updating, by the computer, the task schedule during execution of the task schedule to adjust for breakdowns or loss of functionality in resources.

15. A non-transitory computer-readable medium embodied with software for generating and scheduling resource usage tasks, the software when executed is configured to:
identify changes in a resource usage plan within a supply chain network;
generate tasks based on the identified changes;
determine a task priority of the generated tasks;
generate a task schedule based on the determined task priority; and
monitor real time execution of the generated tasks according to the task schedule.

16. The non-transitory computer-readable medium of claim 15, wherein the monitoring is performed via devices associated with the supply chain network.

17. The non-transitory computer-readable medium of claim 15, wherein the monitoring is performed by cameras or other sensors in the supply chain network.

18. The non-transitory computer-readable medium of claim 15, wherein the task schedule allocates usage of equipment and vehicles.

19. The non-transitory computer-readable medium of claim 15, wherein the software when executed is further configured to:
perform, in real time, dynamic re-sequencing and dynamic re-scheduling to account for a deviation from the schedule.

20. The non-transitory computer-readable medium of claim 15, wherein the software when executed is further configured to:
detect an error in real time and transmit, in real time, one or more tasks to a mobile device to account for the detected error.
